(19) United States
(12) Patent Application Publication
(10) Pub. No.: US 2010/0177411 A1
(43) Pub. Date: Jul. 15, 2010

(54) WAFER LEVEL LENS REPLICATION ON MICRO-ELECTRICAL-MECHANICAL SYSTEMS

(76) Inventors: Shashikant Hegde, Boide, ID (US); Jacques Duparre, Jena (DE); Rick Lake, Meridian, ID (US); Ulrich C. Boettiger, Boise, ID (US)

Correspondence Address: DICKSTEIN SHAPIRO LLP, 1825 EYE STREET NW, Washington, DC, 20006-5403, US

(21) Appl. No.: 12/351,366

(22) Filed: Jan. 9, 2009

(51) Int. Cl. G02B 7/02

(52) U.S. Cl. 359/823

(57) ABSTRACT

Movable lens structures in which a lens is formed on a micro-electrical-mechanical system and methods of making the same. A method of forming the lens includes forming a micro-electrical-mechanical system on a substrate, arranging a first mold inside the micro-electrical-mechanical system, and forming a lens on the micro-electrical-mechanical system using the first mold.

### FIELD OF THE INVENTION

Embodiments described herein relate generally to processes of forming lens wafers for use in imaging devices, and more specifically to processes of forming wafer-level lenses connected to and movable by micro-electrical-mechanical systems (MEMS) technology.

### BACKGROUND OF THE INVENTION

Microelectronic imaging devices are used in a multitude of electronic devices. As microelectronic imaging devices have decreased in size and improvements have been made with respect to image quality and resolution, they are now commonly found in electronic devices including mobile telephones and personal digital assistants (PDAs) in addition to their uses in digital cameras.

Microelectronic imaging devices include image sensors that typically use charged coupled device (CCD) systems or complementary metal-oxide semiconductor (CMOS) systems, or other semiconductor imaging systems. The lenses for these microelectronic imaging devices may require mobility for operations such as automatic focus or zoom features. To meet the increased need for smaller lenses with retained mobility, MEMS technology has been incorporated for lens movement. MEMS is a relatively new technology that exploits the existing microelectronics infrastructure to create complex machines with micron feature sizes. MEMS structures have been created for lens movement and may be integrated with lenses to be used as, e.g., an automatic focus (autofocus) or zoom system by accurately changing the relative distance of the lenses with respect to each other and/or with respect to a pixel array. Some examples of MEMS structures coupled to and used for lens movement may be found in U.S. Pat. Nos. 7,242,541, 7,280,290, and 6,636,653.

Possible techniques for joining a lens to an associated MEMS structure can be complex and expensive. What is needed, therefore, is a simple method for directly replicating a lens onto a MEMS structure using wafer level processes.

### BRIEF DESCRIPTION OF THE DRAWINGS

FIG. 1A shows a wafer structure at a stage of manufacture according to an embodiment described herein.

FIG. 1B shows a wafer structure at a stage of manufacture according to an embodiment described herein.

FIG. 1C shows a wafer structure at a stage of manufacture according to an embodiment described herein.

FIG. 1D shows a wafer structure at a stage of manufacture according to an embodiment described herein.

FIG. 1E shows a wafer structure combined with an imager wafer to form an imaging device according to an embodiment described herein.

FIG. 1F shows a wafer structure combined with an imager wafer to form a plurality of imaging devices according to an embodiment described herein.

FIG. 2A shows a wafer structure at a stage of manufacture according to an embodiment described herein.

FIG. 2B shows a wafer structure at a stage of manufacture according to an embodiment described herein.

FIG. 2C shows a wafer structure at a stage of manufacture according to an embodiment described herein.

FIG. 2D shows a wafer structure at a stage of manufacture according to an embodiment described herein.

FIG. 2E shows a wafer structure at a stage of manufacture according to an embodiment described herein.

FIG. 2F shows a wafer structure combined with an imager wafer to form an imaging device according to an embodiment described herein.

FIG. 3A shows a wafer structure at a stage of manufacture according to an embodiment described herein.

FIG. 3B shows a wafer structure at a stage of manufacture according to an embodiment described herein.

FIG. 3C shows a wafer structure at a stage of manufacture according to an embodiment described herein.

FIG. 3D shows a wafer structure at a stage of manufacture according to an embodiment described herein.

FIG. 3E shows a wafer structure at a stage of manufacture according to an embodiment described herein.

FIG. 3F shows a wafer structure at a stage of manufacture according to an embodiment described herein.

FIG. 3G shows a wafer structure combined with an imager wafer to form an imaging device according to an embodiment described herein.

FIG. 4 illustrates a block diagram of a CMOS imaging device constructed in accordance with an embodiment described herein.

FIG. 5 depicts a system constructed in accordance with an embodiment described herein.

### DETAILED DESCRIPTION OF THE INVENTION

In the following detailed description, reference is made to various embodiments that are described with sufficient detail to enable those skilled in the art to practice them. It is to be understood that other embodiments may be employed, and that various structural or logical changes may be made.

Embodiments described herein relate to a method of making wafer level integrated lens/MEMS structures by forming wafer-level lenses on wafer level MEMS structures. The integrated wafer level structure can then be further integrated with an imager wafer to form a plurality of imaging devices, which are diced from the wafer to form individual imaging devices having integrated lenses and MEMS structures. The embodiments described herein provide a high-throughput wafer level process that will result in smaller, more reliable, and easier to produce autofocus and zoom systems.

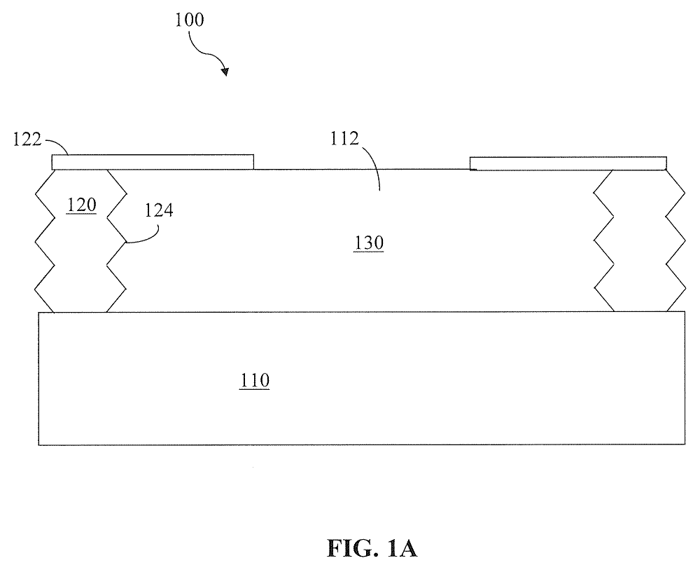

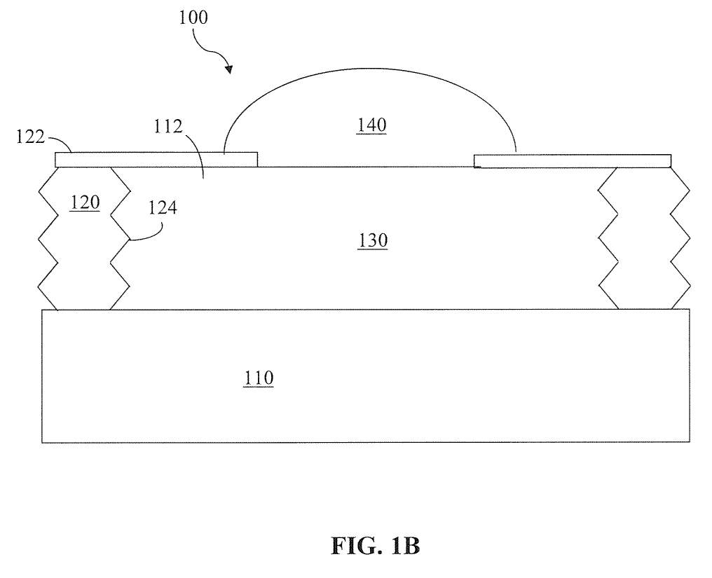

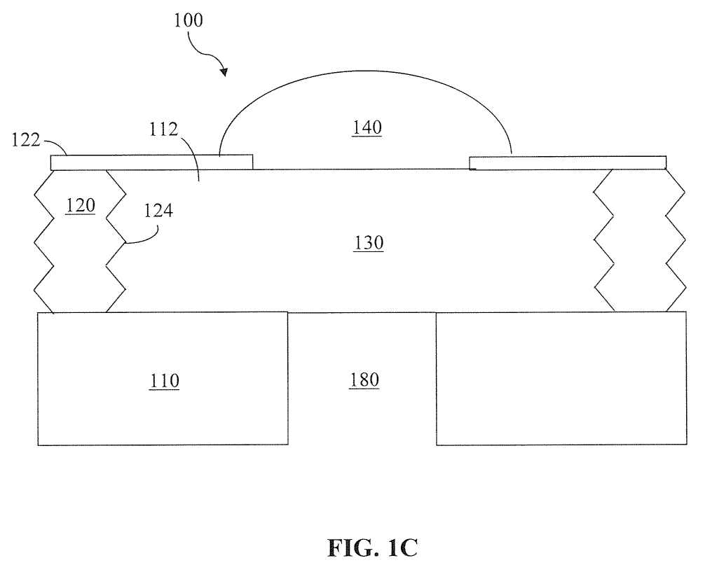

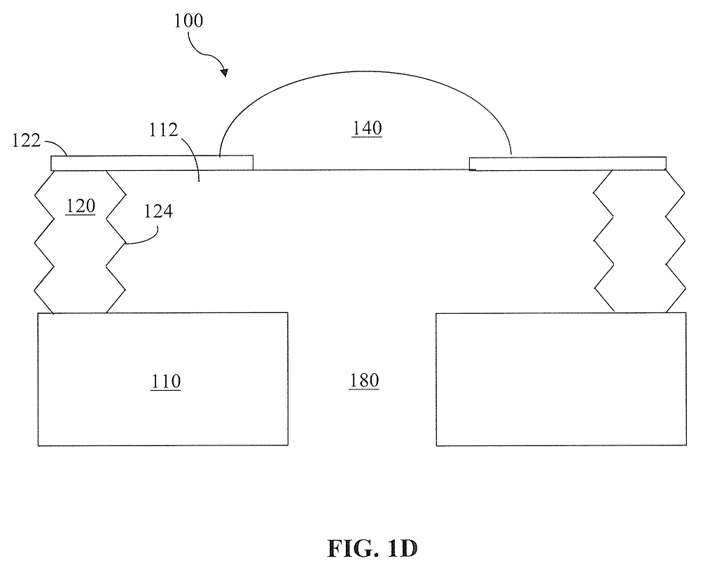

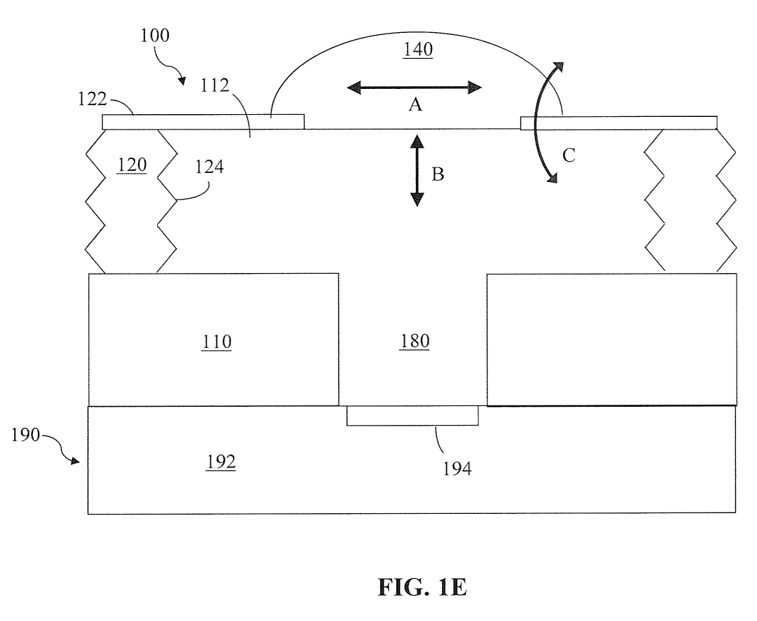

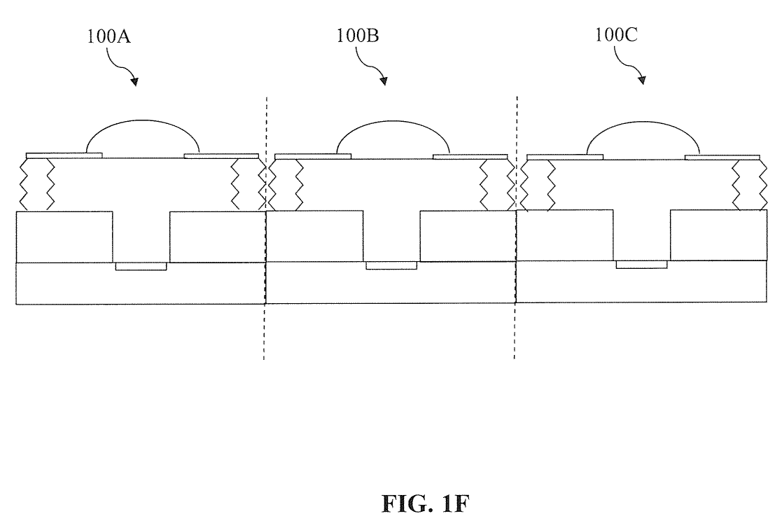

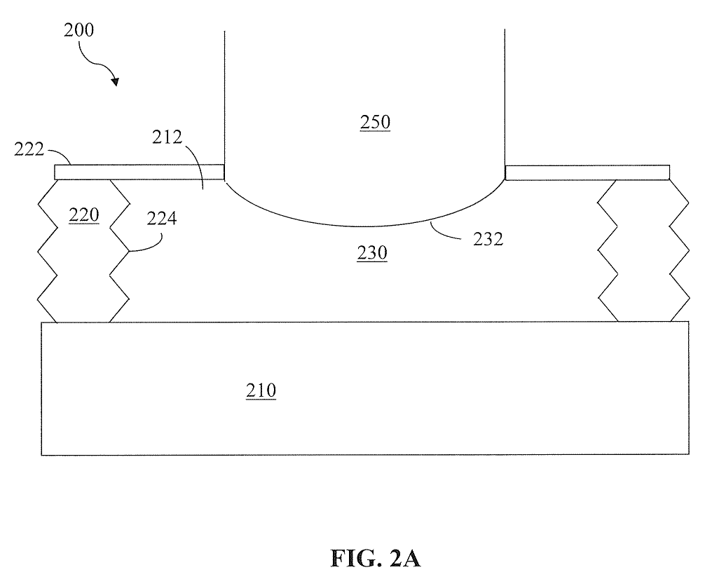

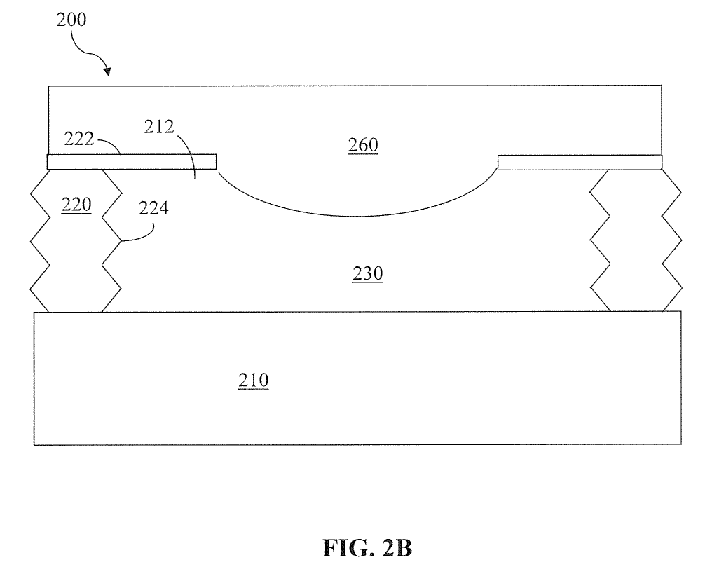

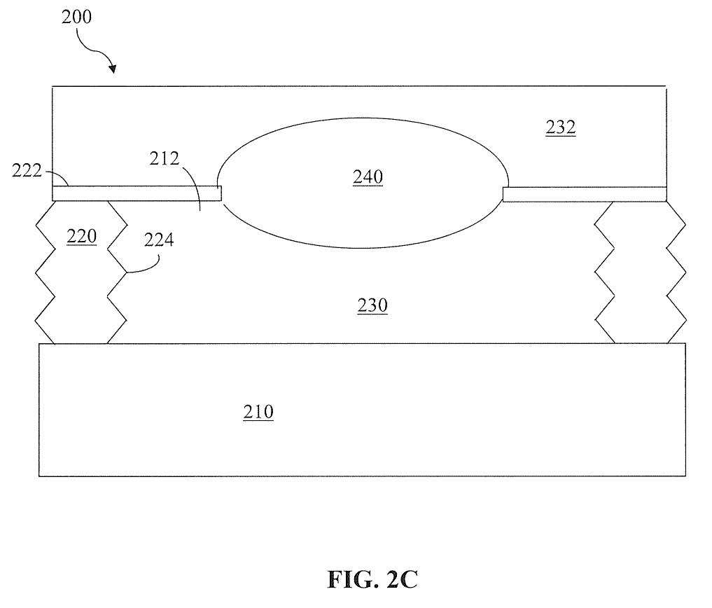

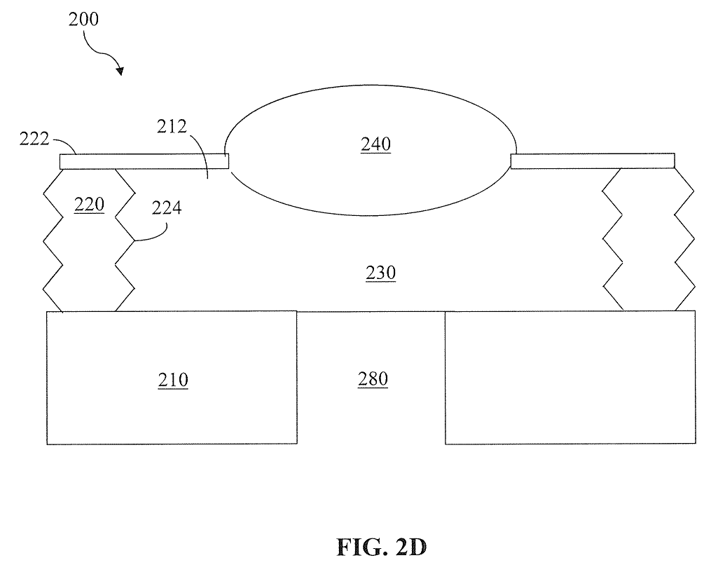

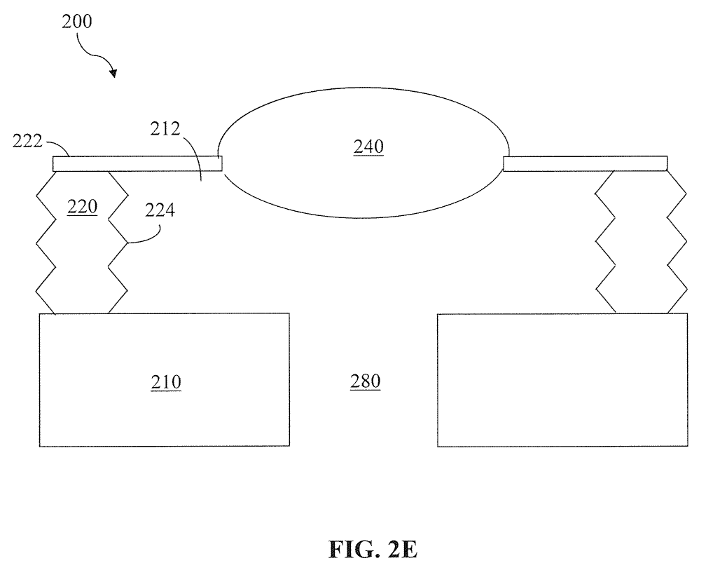

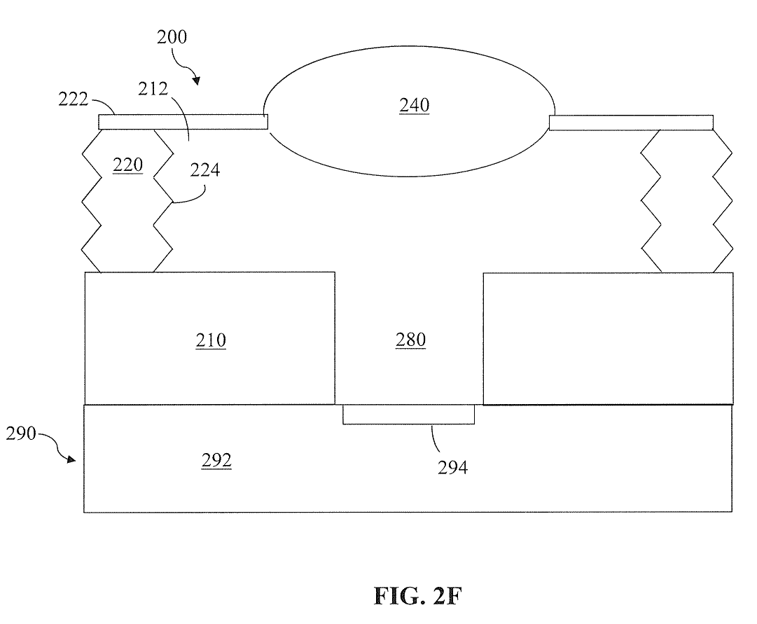

Now referring to the figures, where like reference numbers designate like elements, FIGS. 1A-1D show an embodiment of a method of forming a wafer structure 100 having a wafer-level lens 140 attached to a MEMS lens moving structure 120. The MEMS lens moving structure 120 may include a lens support 122, and can be any structure capable of moving a lens relative to a pixel array (e.g., array 294 of FIG. 2F). FIG. 1A shows a portion of wafer structure 100 showing just one MEMS lens moving structure 120 of a wafer at a first stage of manufacture. The structure 100 includes a substrate 110, which may be transparent, a MEMS lens moving structure 120, and a sacrificial mold 130 formed within an opening 112 defined by side wall portions 124 of the MEMS structure 120.

The MEMS lens moving structure 120, is formed on the substrate 110. The MEMS lens moving structure 120 may have bending parts, such as hinges or actuators, or it may have linearly movable parts. The MEMS lens moving structure 120 may employ, for example, a piezoelectric, electrostatic or microelectric lens moving structure. The MEMS lens moving structure 120 may be formed on the substrate 110 by methods such as surface micromachining, bulk micromachining, and LIGA (meaning Lithographie, Galvanoformung, Abformung) (and variations thereof). The MEMS lens moving structures 120 may impart vertical or horizontal linear movement or rotational movement to a lens support element 122 as shown by the arrows in FIG. 1E.

Surface micromachining is accomplished by three basic techniques: deposition of thin films followed by wet chemical etching and/or dry etching techniques. The most common form of dry etching for micromachining application is reactive ion etching (RIE). Ions are accelerated towards the material to be etched, and the etching reaction is enhanced in the direction of travel of the ion. RIE is an anisotropic etching technique. Trenches and pits many microns deep of arbitrary shape and with vertical sidewalls can be etched by prior art techniques in a variety of materials, including silicon, oxide, and nitride. Dry etching techniques can be combined with wet etching to form various micro devices. “V” shaped grooves or pits with tapered sidewalls can be formed in silicon by anisotropic etching with KOH etchant. Another etching technique, with roots in semiconductor processing, utilizes plasma etching.

A sacrificial mold 130 is formed inside the MEMS lens moving structure 120 by a method such as, for example, vapor deposition, spin coated, dispensing, or sputtering. The sacrificial mold 130 may be formed of a material that may be dissolved, such as SiO₂ or a polymer, for example, polynorbornene, polycarbonate, polyvinyl alcohol, or an ultra-violet curable polymer.

As shown in FIG. 1B, a wafer-level lens 140 may be imprinted on top of the sacrificial mold 130 and the MEMS lens moving structure 120 by a lens replication method. In one embodiment, the lens 140 may be formed of ultra-violet curable material by selective ultra-violet replication using a stamp with a mask pattern. The ultra-violet curable material may be puddle dispensed or may be applied as a layer onto the sacrificial mold 130 and MEMS lens moving structure 120. A second mold having a lens mold cavity is brought into increasingly closer contact with the material until the material flows out to the desired diameter and fills the entire lens mold cavity. The ultraviolet curable material may then be cured to form the lens 140 and the uncured material between lenses 140 may be removed by wet or dry etching. In another embodiment, discrete drops of ultra-violet curable polymer are formed on the sacrificial mold 130 and MEMS lens moving structure 120 and then stamped with a second mold, for example a lens pin, to form the lens 140.

While the wafer-level lens 140 shown in the embodiment of FIG. 1B is convex, it should be understood that concave or partially concave lenses may also be formed. The lens 140 may be formed of a rigid material (e.g., an Ormocer® such as Ormocomp®, manufactured by Microresist Technology GmbH, Berlin, Germany) or a flexible material (e.g., polydimethylsiloxane (“PDMS”)). When the lens 140 is formed of rigid material, the movement of the lens 140 is restricted to axial or rotational movement by the MEMS lens moving structure 120 as shown by arrows A and C (FIG. 1E). When the lens 140 is formed of a flexible material, the shape of the lens itself may be changed by the MEMS lens moving structure 120 by stretching or otherwise distorting the lenses as shown by arrow B (FIG. 1E).

As shown in FIG. 1C, once the lens 140 is formed, the substrate 110, e.g., a silicon substrate, may be etched from the backside of the substrate 110 to expose the sacrificial mold 130. The substrate 110 may be etched by any suitable method to form one or more openings 180 as required to later dissolve and remove the sacrificial mold 130. In one embodiment, the opening 180 is aligned with the optical path to transmit light passing through the lens 140. As shown in FIG. 1D, the sacrificial mold 130 may be completely dissolved to form a cavity within the MEMS lens moving structure 120 and to leave the lens 140 attached to the MEMS lens moving structure 120. In an alternative embodiment, the mold 130 is transparent and is not removed. As shown in FIG. 1E, the completed wafer structure 100 may be combined with an imager wafer 190 by aligning a pixel array 194 on the substrate 192 of the imager wafer 190 with the lens 140 of the wafer structure 100 to provide a plurality of wafer level imaging devices 100A, 100B, 100C, as shown in FIG. 1F. As also shown in FIG. 1F, the wafer level imaging devices 100A, 100B, 100C may be diced into a plurality of singularized imaging devices.

FIGS. 2A-2E show another example embodiment of a method of forming a wafer structure 200 having a wafer-level lens 240 (FIG. 2C) attached to a MEMS lens moving structure 220 having an associated lens support structure 222. FIG. 2A shows a portion of the wafer structure 200 at an early stage of manufacture. The wafer structure 200 includes a transparent substrate 210, a MEMS lens moving structure 220 fabricated on substrate 210, and a sacrificial mold 230 formed of a material suitable for embossing.

As shown in FIG. 2A, a depression 232 is embossed into the sacrificial mold 230 using a lens pin 250. In one embodiment, the sacrificial mold 230 may be embossed using a hot embossing method and may be formed of a material suitable for such a method, such as polycarbonate. In another embodiment, the sacrificial mold 230 may be an ultra-violet curable material and may be embossed by a standard ultra-violet embossing process.

As shown in FIG. 2B, an ultra-violet curable resist 260 is formed on the MEMS lens moving structure 220, including the lens support 222, and the sacrificial mold 230 by any suitable method such as, for example, deposition or spin coating. As shown in FIG. 2C, a discrete lens 240 is formed on top of the MEMS lens moving structure 220 and the sacrificial mold 230, by methods described above with reference to FIGS. 1A-1E. For example, in the embodiment shown in FIG. 2B, an ultraviolet curable resist 260 is applied to the surface of the MEMS lens moving structure 220 and the sacrificial mold 230. As shown in FIG. 2C, a second mold 232 is applied to the curable resist 260 to form the lens 240. The lens 240 is cured and the excess ultraviolet curable resist 260 is removed to leave the cured lens 240 on top of the MEMS lens moving structure 220 and the sacrificial mold 230, as shown in FIG. 2D.

As further shown in FIG. 2D, once the lens 240 is formed, the substrate 210 may be etched from the backside to expose the sacrificial mold 230. The substrate 210 may be etched by any suitable method to form one or more openings 280 as required to later dissolve and remove the sacrificial mold 230. As shown in FIG. 2E, the sacrificial mold 230 may be completely dissolved to leave the lens 240 attached to the MEMS lens moving structure 220. In an alternative embodiment, the mold 230 is transparent and is not removed. As shown in FIG. 2F, the completed wafer structure 200 may be combined with an imager wafer 290 by aligning a pixel array 294 on the substrate 292 of the imager wafer 290 with the lens 240 and associated MEMS structure 220 to provide a plurality of imaging devices on the integrated wafers in the same manner as shown in FIG. 1F.

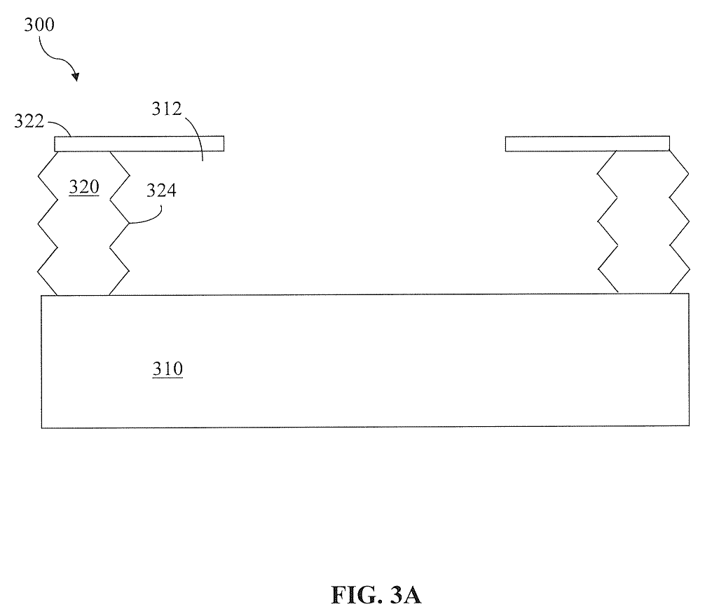

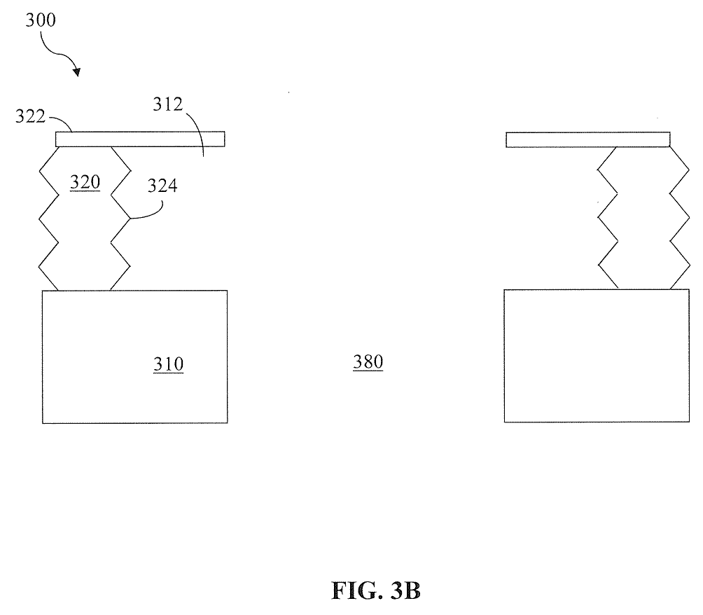

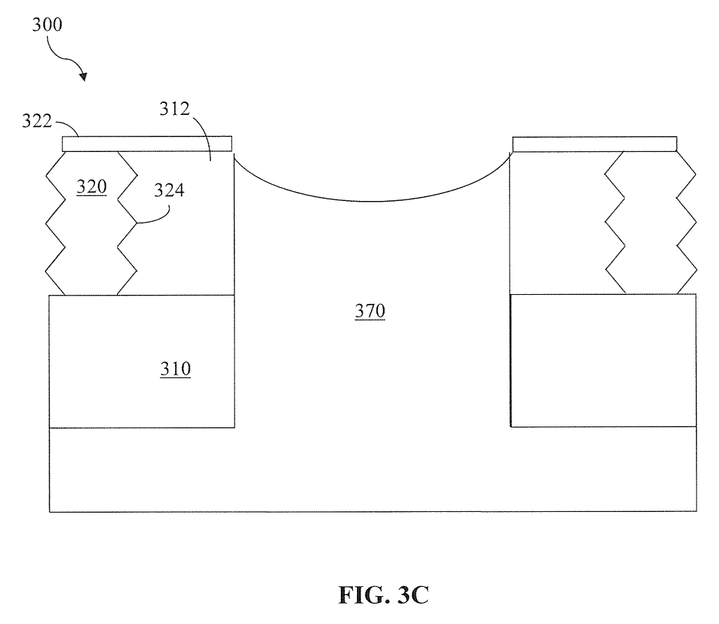

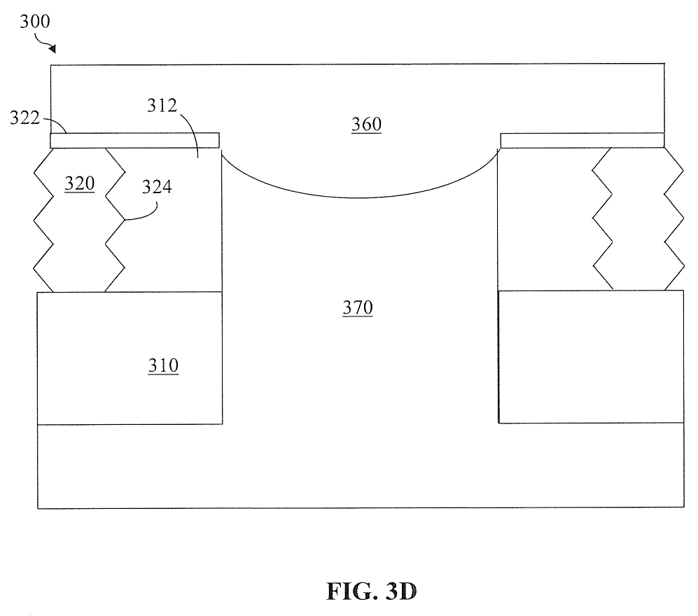

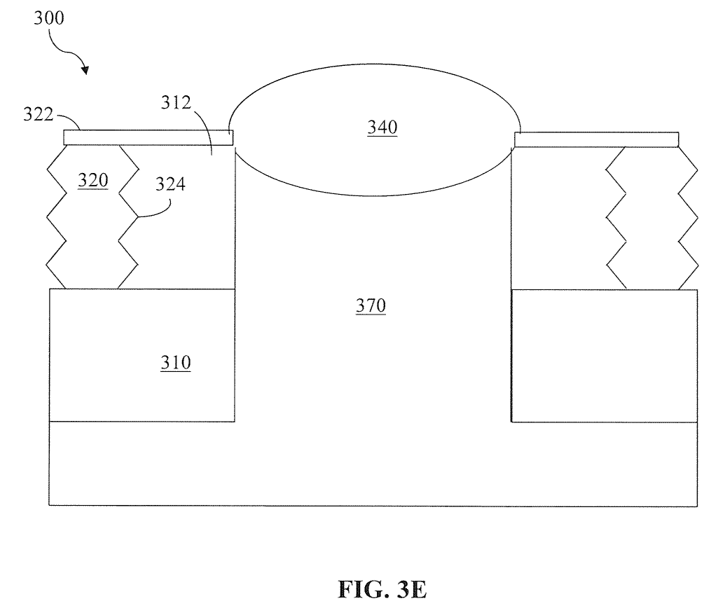

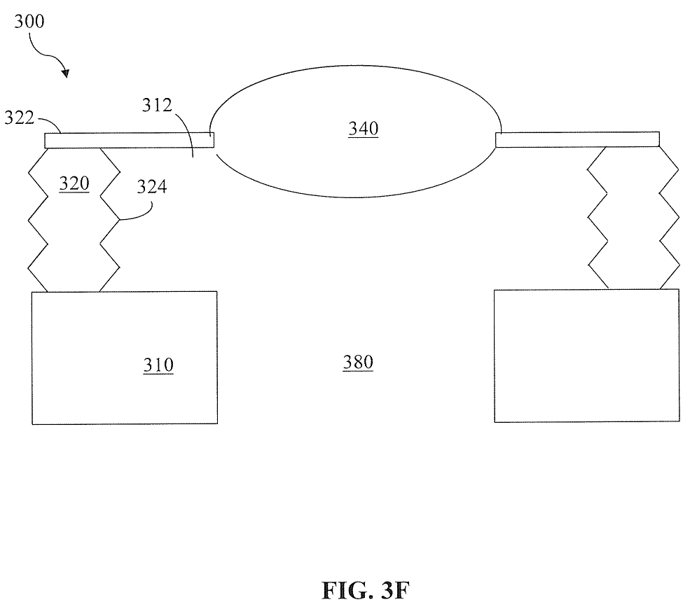

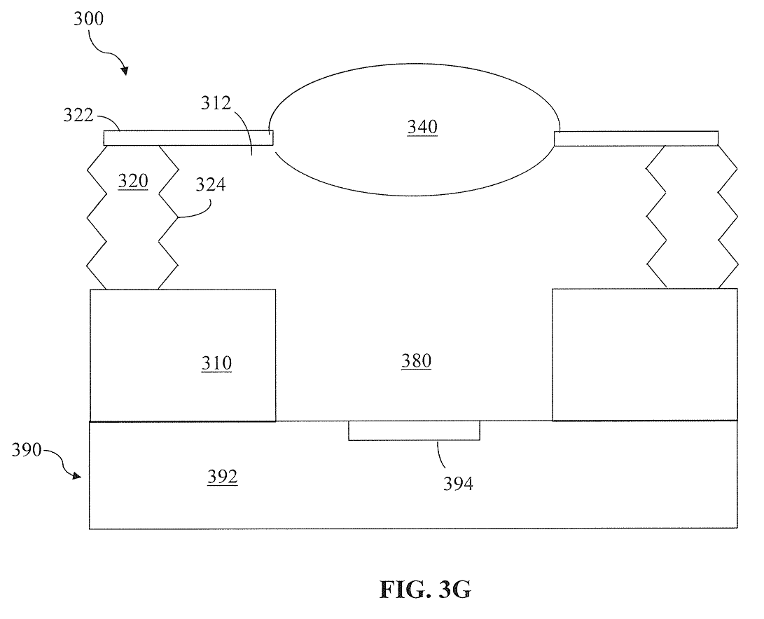

FIGS. 3A-3G show another example embodiment of a method of forming a wafer structure 300 including wafer-level lens 340 (FIG. 3E) attached to a MEMS lens moving structure 320. FIG. 3A shows a portion of the wafer structure 300 in a stage of manufacture that includes a transparent substrate 310 and a MEMS lens moving structure 320.

As shown in FIG. 3B, an opening 380 is etched by any suitable method through the backside of the substrate 310 and aligned with the MEMS lens moving structure 320. As shown in FIG. 3C, a lens mold 370 is formed in or inserted into the opening 380 from the backside of the substrate 310 by any suitable method. As shown in FIG. 3D, an ultra-violet curable resist 360 is formed on the MEMS lens moving structure 320, including the lens support 322, and on the lens mold 370 by a method such as, e.g., deposition or spin coating. As shown in FIG. 3E, a discrete lens 340 is formed on top of the MEMS lens moving structure 320 and associated lens support 322 and the lens mold 370 by methods such as the ones described above with respect to FIGS. 1A-1E. For example, in the embodiment shown in FIG. 3D, a second mold is applied to the curable resist 360 to form the lens 340. The lens 340 is cured and the excess ultraviolet curable resist 360 is removed to leave the cured lens 340 on top of the MEMS lens moving structure 320 and the sacrificial mold 370

As shown in FIG. 3F, the lens mold 370 is removed from the opening 380 either by mechanical means or by dissolving the lens mold 370. In an alternative embodiment, the lens mold 370 is transparent and is left attached to the wafer structure 300. As shown in FIG. 3G, the completed wafer structure 300 may be combined with an imager wafer 390 by aligning a pixel array 394 on the substrate 392 of the imager wafer 390 with the lens 340 and MEMS structure 320 of the wafer structure 300 to provide an imaging device.

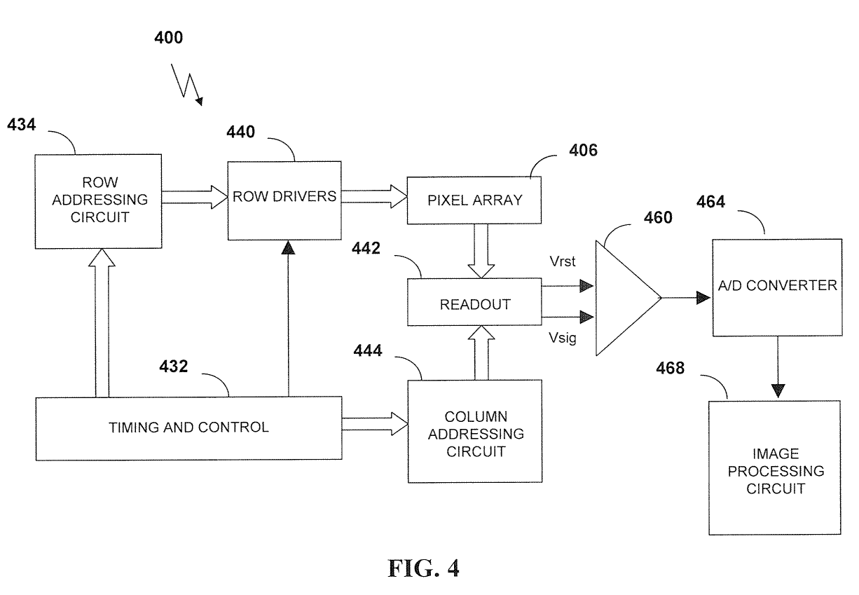

FIG. 4 shows a block diagram of a CMOS imaging device 400 that may use a structure 100, 200, 300 according to embodiments described herein. Although a CMOS imaging device is shown, any type of imaging device including those based on CCD and other solid state imaging technology can be used. A timing and control circuit 432 provides timing and control signals for enabling the reading out of signals from pixels of the pixel array 406 in a manner commonly known to those skilled in the art. The pixel array 406 has dimensions of M rows by N columns of pixels, with the size of the pixel array 406 depending on a particular application.

Signals from the imaging device 400 may be read out a row at a time using a column parallel readout architecture. The timing and control circuit 432 selects a particular row of pixels in the pixel array 406 by controlling the operation of a row addressing circuit 434 and row drivers 440. Signals stored in the selected row of pixels are provided to a readout circuit 442. The signals are read from each of the columns of the array sequentially or in parallel using a column addressing circuit 444. The pixel signals, which include a pixel reset signal Vᵣₛₜ and image pixel signal V_{sig}, are provided as outputs of the readout circuit 442, and are typically subtracted in a differential amplifier 460 with the result digitized by an analog-to-digital (AID) converter 464 to provide digital pixel signals. The digital pixel signals represent an image captured by an example pixel array 406 and are processed in an image processing circuit 468 to provide an output image.

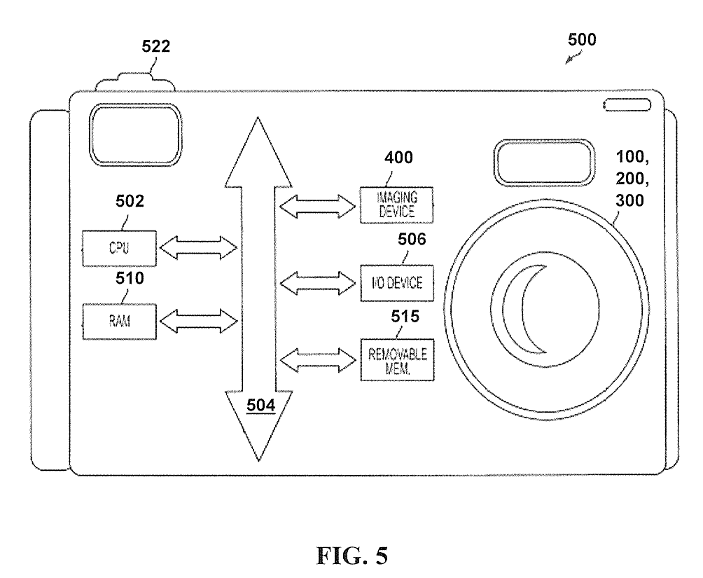

FIG. 5 shows a system 500 that includes an imaging device 400 and a structure 100, 200, 300 constructed in accordance with the various embodiments described above. The system 500 is a system having digital circuits that include imaging device 400. Without being limiting, such a system could include a computer system, camera system, scanner, machine vision, vehicle navigation, video telephone, surveillance system, autofocus system, star tracker system, motion detection system, image stabilization system, or other image acquisition system.

System 500, e.g., a digital still or video camera system, generally comprises a central processing unit (CPU) 502, such as a control circuit or microprocessor for conducting camera functions, including operating the MEMS structures described herein, that communicates with one or more input/output (I/O) devices 506 over a bus 504. Imaging device 400 also communicates with the CPU 502 over the bus 504. The processor system 500 also includes random access memory (RAM) 510, and can include removable memory 515, such as flash memory, which also communicates with the CPU 502 over the bus 504. The imaging device 400 may be combined with the CPU processor with or without memory storage on a single integrated circuit or on a different chip than the CPU processor. In a camera system, a structure 100, 200, 300 according to various embodiments described herein may be used to focus image light onto the pixel array 406 of the imaging device 400 and an image is captured when a shutter release button 522 is pressed.

While embodiments have been described in detail in connection with the embodiments known at the time, it should be readily understood that the claimed invention is not limited to the disclosed embodiments. Rather, the embodiments can be modified to incorporate any number of variations, alterations, substitutions or equivalent arrangements not heretofore described. For example, while some embodiments are described in connection with a CMOS pixel imaging device, they can be practiced with any other type of imaging device (e.g., CCD, etc.) employing a pixel array. Also, although the embodiments depicted herein show one MEMS lens moving structure and wafer-level lens arranged on each substrate, it should be understood that in practice many MEMS structures and associated lenses (tens, hundreds, or thousands) may be formed at the same time on an associated wafer substrate. Accordingly, the claimed invention is not limited by the embodiments described herein but is only limited by the scope of the appended claims.

What is claimed as new and desired to be protected by Letters Patent of the United States is:

1. A method of making a movable lens structure, the method comprising:
forming a lens moving structure on a substrate, the substrate and the lens moving substrate defining a cavity;
arranging a first mold inside the cavity; and
forming a lens on the lens moving structure and the first mold.

2. The method of claim 1, further comprising removing the first mold from the cavity.

3. The method of claim 1, further comprising forming an opening in the substrate to expose the first mold.

4. The method of claim 3, further comprising removing the first mold from the cavity by dissolving the first mold and extracting the dissolved first mold through the opening.

5. The method of claim 3, wherein the first mold is arranged inside the cavity by inserting the first mold through the opening.

6. The method of claim 5, wherein the first mold is removed from inside the cavity by withdrawing the first mold through the opening.

7. The method of claim 1, further comprising arranging the first mold inside the cavity by deposition or sputtering.

8. The method of claim 1, further comprising embossing the first mold to form a lens shaped depression after arranging the first mold inside the cavity and before forming the lens.

9. The method of claim 1, wherein the first mold comprises polynorbornene, polycarbonate, polyvinyl alcohol, or an ultra-violet curable polymer.

10. The method of claim 1, wherein the lens is formed by arranging curable material on the first mold and the lens moving structure and shaping the ultra-violet curable material between the first mold and a second mold to form the lens.

11. The method of claim 1, wherein the lens moving structure comprises a micro-electrical-mechanical system.

12. A method of making a lens wafer, the method comprising:
forming a plurality of micro-electrical-mechanical systems on a first substrate;
respectively providing a plurality of first molds inside the plurality of micro-electrical-mechanical systems;
providing a curable material on the first molds and on the plurality of micro-electrical-mechanical systems;
shaping the curable material, using the plurality of first molds and a plurality of second molds, into a plurality of lenses respectively associated with the plurality of the micro-electrical-mechanical systems;
forming a plurality of openings at locations corresponding to the micro-electrical-mechanical systems through the substrate; and
removing the first molds from inside of the plurality of micro-electrical-mechanical systems.

13. The method of claim 12, wherein:
the plurality of openings are formed after shaping the curable material; and
wherein the plurality of first molds are removed through the plurality of openings by dissolving the first molds.

14. The method of claim 12, wherein:
the plurality of openings are formed before shaping the curable material; and
the plurality of first molds are arranged inside the plurality of micro-electrical-mechanical systems by inserting the plurality of first molds through the plurality of openings.

15. A method of forming an imaging device comprising:
forming a first wafer by a method comprising:
forming a micro-electrical-mechanical system on a substrate,
arranging a first mold inside the micro-electrical-mechanical system,
forming a lens on the micro-electrical-mechanical system using the first mold,
removing the first mold from inside the micro-electrical-mechanical system; and
coupling the first wafer to a second wafer containing a pixel array, such that said pixel array can receive an image through said lens.

16. The method of claim 15, wherein the lens is formed by arranging curable material on the first mold and the lens moving structure and shaping the ultra-violet curable material between the first mold and a second mold to form the lens.

17. A lens structure comprising:
a substrate;
a micro-electrical-mechanical system arranged on the substrate; and
a lens connected to the micro-electrical-mechanical system.

18. The lens structure of claim 17, further comprising an opening formed in the substrate.

19. The lens structure of claim 18, wherein the opening is aligned with the micro-electrical-mechanical system.

20. The lens structure of claim 18, further comprising a cavity arranged inside the micro-electrical-mechanical system and between the lens and the substrate.

21. The lens structure of claim 17, wherein the lens comprises a first curved side facing away from the substrate and a second substantially flat side facing towards the substrate.

22. The lens structure of claim 17, wherein the lens comprises a first curved side facing away from the substrate and a second curved side facing towards the substrate.

23. The lens structure of claim 17, wherein the lens comprises an ultra-violet curable material.

24. An imaging device comprising:
a first wafer comprising:
a substrate,
a micro-electrical-mechanical system arranged on the substrate,
a lens connected directly to the micro-electrical-mechanical system,
an opening formed in the substrate, and
a cavity arranged inside the micro-electrical-mechanical system; and
a second wafer coupled to the first wafer and comprising a pixel array and associated circuitry,
wherein the pixel array is aligned with the lens.

25. The imaging device claim 24, wherein the micro-electrical-mechanical system is capable of adjusting a distance between the lens and the pixel array.
